(19) United States
(12) Patent Application Publication
(10) Pub. No.: US 2024/0296459 A1
(43) Pub. Date: Sep. 5, 2024

(54) GREEN SUPPLY CHAIN PARTNER RECOMMENDER

(71) Applicant: Hitachi, Ltd., Tokyo (JP)

(72) Inventors: Prasun Kumar SINGH, San Jose, CA (US); Malarvizhi SANKARANARAYANASAMY, Mountain View, CA (US); Ravigopal VENNELAKANTI, San Jose, CA (US); Amit KUMAR, San Jose, CA (US)

(21) Appl. No.: 18/117,040

(22) Filed: Mar. 3, 2023

(51) Int. Cl. G06Q 30/018

(52) U.S. Cl. CPC G06Q 30/018

(57) ABSTRACT

In example implementations described herein, there are systems and methods for obtaining information relating to one or more of a GHG consumption or a GHG production associated with a plurality of entities associated with a GHG-offset marketplace; receiving a request regarding a desired transaction related to the GHG-offset marketplace; and recommending, based on the request and the information relating to the one or more of the GHG consumption or the GHG production, at least one optimized set of partner entities in the plurality of entities for fulfilling the request. The recommendation of the at least one optimized set of partner entities may be included as part of selecting and coordinating partnerships in a supply chain (e.g., for a supply chain management company) to reduce and/or optimize greenhouse gas emissions and to enable effective cooperation for various supply chain objectives.

### BACKGROUND

### Field

The present disclosure is generally directed to greenhouse gas emissions associated with a supply chain and a method for selecting and coordinating partnerships in a supply chain to reduce and/or optimize greenhouse gas emissions and to enable effective cooperation for various supply chain objectives.

### Related Art

Emissions of greenhouse gases related to human activities are understood to be a major cause of increase in global warming that is estimated to have catastrophic climate change in the near future. Among the greenhouse gases (GHG), carbon dioxide (CO₂) is considered by many to be the main driver of climate change. Accordingly, there is a push to achieve “net zero” carbon dioxide emissions by 2050. However, certain human activities may not be possible to be performed “carbon-free”. For such activities a carbon dioxide producer may purchase carbon-credits, e.g., they may pay someone else to reduce their emissions or capture their carbon to achieve carbon-neutrality (“net zero” emissions).

For example, if a business organization cannot stop emitting CO₂, then it can ask another organization to emit less CO₂ so that it continues producing CO₂ but the total amount of carbon in the atmosphere is maintained or reduced. Through the cooperation of multiple organizations and/or entities, a more optimal distribution of carbon emissions (or carbon footprints) may be achieved. In some aspects, carbon credit types may include (1) credit from reduced emissions, e.g., energy efficiency operations, (2) credit by removed emissions, e.g., planting forests, or (3) credit by avoiding emissions e.g., preventing cutting of rainforests. Business organizations can purchase carbon credits that are generally traded in for their emissions to meet their climate targets. Carbon credits are generally traded in units of one ton of CO₂.

FIG. 1 is a diagram 100 illustrating elements of a carbon credit lifecycle marketplace currently in common practice. In some aspects, a carbon credit project may be proposed by a project developer 110. The project may include, e.g., a conservation project 111 (preventing the destruction of a carbon sink such as a forested area), a green energy installation 112 (preventing additional GHG and/or CO₂ emissions), or a reforestation project 113 (capturing carbon in the trees). The project may be evaluated and verified 114 by a third party (e.g., a certification organization or governmental office) to determine a number of tons of CO₂ the project may be used to offset. A carbon offset wholesaler and/or retailer 120 may be notified of the availability of the verified and/or certified carbon offset and may then coordinate the sale of the carbon offset between the project developer 110 and a carbon credit end buyer 130. The carbon credit end buyer 130 may then perform activities producing CO₂ and/or GHGs while maintaining carbon-neutrality (or GHG-neutrality) based on the purchased carbon offset. Once the CO₂ producing activities are performed (e.g., the purchased carbon offset is used), the carbon credit project expires and/or is retired.

As time goes on, there may be a shift from a voluntary carbon market (VCM) to a mandatory (or statutory) carbon market (MCM). GHG accounting standards are emerging to define and account for direct and indirect carbon emissions. Supply chain partner internal activities contributing to direct and indirect carbon emissions—can be offset by purchasing carbon credits or executing carbon capture projects. Future statutory and/or mandatory carbon markets may have requirements to have multi-party validations, tracking, and tracing enabling a ‘single truth’ among the supply chain partners of an organization.

Currently carbon emission reporting by organizations is voluntary and is reported as part of corporate social responsibility and accountability. The current trend of green supply chain partner selection by most organizations is based more on qualitative data measured as implementation of best practices that may be provided on a best effort basis. However, as the markets move from VCM to MCM, challenges related to choosing supply chain partners to reduce total carbon emission for a market participant in a measurable (e.g., quantitative) and verifiable manner may become more important.

### SUMMARY

Example implementations described herein involve an innovative method to provide (1) a GHG marketplace that satisfies the desire for quantifiable and verifiable GHG consumption and/or production (e.g., a total GHG impact of a set of processes and or projects) and (2) to provide recommendations for GHG offset partners and/or transactions based on the information used to define the GHG marketplace. In some aspects, the innovative method or apparatus may receive information relating to one or more of a GHG consumption or a GHG production from a plurality of entities associated with a GHG-offset marketplace (e.g., a carbon credit (CC) marketplace). The method or apparatus may then receive a request regarding a desired transaction related to the GHG-offset marketplace and recommend, based on the request and the information relating to the one or more of the GHG consumption or the GHG production, at least one optimized set of partner entities in the plurality of entities for fulfilling the request. The information relating to one or more of a GHG consumption or a GHG production from a plurality of entities associated with a GHG-offset marketplace, in some aspects, may be quantifiable and/or verifiable data provided in accordance with a standard by each participant in the GHG marketplace to generate a standardized, single truth, and traceable GHG marketplace (or GHG marketplace model) across the supply chain (e.g., across different actors and different components (-direct and indirect carbon emissions) of the supply chain for each actor).

Aspects of the present disclosure include a method for obtaining information relating to one or more of a GHG consumption or a GHG production associated with a plurality of entities associated with a GHG-offset marketplace; receiving a request regarding a desired transaction related to the GHG-offset marketplace; and recommending, based on the request and the information relating to the one or more of the GHG consumption or the GHG production, at least one optimized set of partner entities in the plurality of entities for fulfilling the request.

Aspects of the present disclosure include a non-transitory computer readable medium, storing instructions for execution by a processor, which can involve instructions for obtaining information relating to one or more of a GHG consumption or a GHG production associated with a plurality of entities associated with a GHG-offset marketplace; receiving a request regarding a desired transaction related to the GHG-offset marketplace; and recommending, based on the request and the information relating to the one or more of the GHG consumption or the GHG production, at least one optimized set of partner entities in the plurality of entities for fulfilling the request.

Aspects of the present disclosure include a system, which can involve means for obtaining information relating to one or more of a GHG consumption or a GHG production associated with a plurality of entities associated with a GHG-offset marketplace; receiving a request regarding a desired transaction related to the GHG-offset marketplace; and recommending, based on the request and the information relating to the one or more of the GHG consumption or the GHG production, at least one optimized set of partner entities in the plurality of entities for fulfilling the request.

Aspects of the present disclosure include an apparatus, which can involve a processor, configured to obtain information relating to one or more of a GHG consumption or a GHG production associated with a plurality of entities associated with a GHG-offset marketplace; receive a request regarding a desired transaction related to the GHG-offset marketplace; and recommend, based on the request and the information relating to the one or more of the GHG consumption or the GHG production, at least one optimized set of partner entities in the plurality of entities for fulfilling the request.

### BRIEF DESCRIPTION OF DRAWINGS

FIG. 1 is a diagram illustrating elements of a carbon credit lifecycle and marketplace.

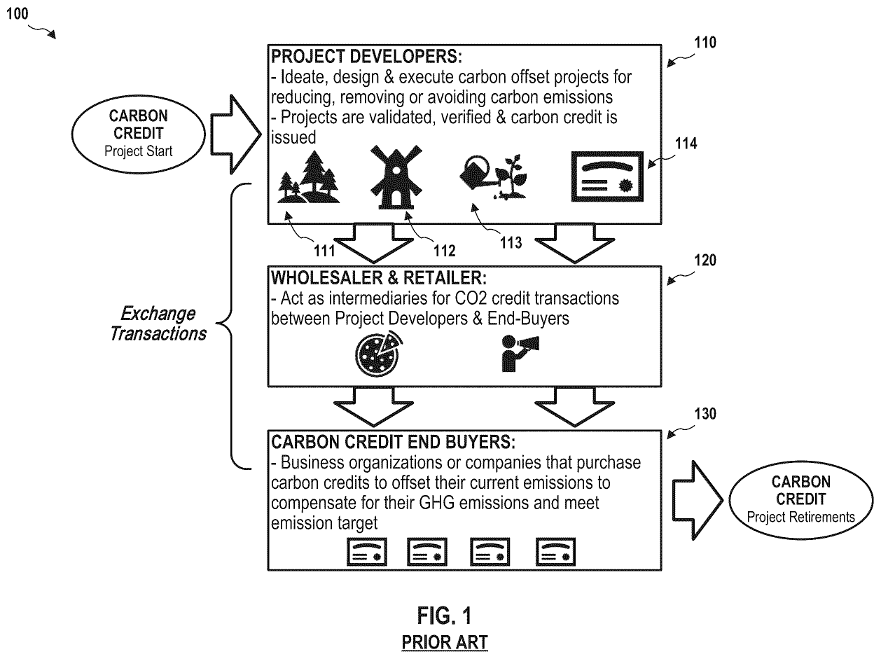

FIG. 2 is a diagram illustrating a set of stakeholders in a GHG marketplace.

FIG. 3 is a diagram illustrating components of a system for recommending partners for a SCM company in accordance with some aspects of the disclosure.

FIG. 4 is a flow figure illustrating a method in accordance with some aspects of the disclosure.

FIG. 5 is a flow diagram illustrating a set of operations for a second pass calculation of a GF value associated with a current recommendation that is further based on the use of carbon credits.

FIG. 6 is a flow diagram illustrating a method in accordance with some aspects of the disclosure.

FIG. 7 is a flow diagram illustrating a method in accordance with some aspects of the disclosure.

FIG. 8 illustrates an example computing environment with an example computer device suitable for use in some example implementations.

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of the ordinary skills in the art practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations.

Example implementations described herein involve an innovative method or apparatus to provide (1) a GHG marketplace that satisfies the desire for quantifiable and verifiable GHG consumption and/or production (e.g., a total GHG impact of a set of processes and or projects) and (2) to provide recommendations for GHG offset partners and/or transactions based on the information used to define the GHG marketplace. In some aspects, the innovative method or apparatus may receive information relating to one or more of a GHG consumption or a GHG production from a plurality of entities associated with a GHG-offset marketplace. The method or apparatus may then receive a request regarding a desired transaction related to the GHG-offset marketplace and recommend, based on the request and the information relating to the one or more of the GHG consumption or the GHG production, at least one optimized set of partner entities in the plurality of entities for fulfilling the request. The information relating to one or more of a GHG consumption or a GHG production from a plurality of entities associated with a GHG-offset marketplace, in some aspects, may be quantifiable and/or verifiable data provided in accordance with a standard by each participant in the GHG marketplace to generate a standardized, single truth, and traceable GHG marketplace (or GHG marketplace model) across the supply chain (e.g., across different actors and different components (scopes of the GHG protocol) of the supply chain for each actor).

Accordingly, a GHG marketplace and/or GHG marketplace model may be built in accordance with aspects of the disclosure to build quantitative models for green supplier (GS) selection. To build the quantitative model (e.g., a single truth or shared view of the underlying marketplace), in some aspects, the supply chain partners and other stakeholders (e.g., participants and/or actors in the GHG marketplace) may share quantitative data that are standardized, traceable, and auditable. The supply chain partners and stakeholders share the single truth of the environmental impact information among the participants and/or actors in the GHG marketplace (e.g., a supply chain consortium) having carbon target reductions and participating in the carbon credit trading ecosystem.

For example, for large organizations it may be important to choose supply chain partners that will enable them to meet mandatory and/or statutory carbon footprint goals. Such mandatory and/or statutory GHG reduction goals may be associated with a need for more evidence-based reporting and commitment to generating a single truth relating to activities that contribute to direct and indirect GHG emissions. In some aspects of the disclosure, the method or apparatus enables companies (e.g., or a supply chain management company (SCM)) participating in the GH marketplace to use GHG emission reporting by their supply chain partners and their commitments for GHG emission reduction to build a probabilistic estimate model for direct and indirect carbon emissions. The method or apparatus, in some aspects, enables each company (or the SCM company) participating in the GH marketplace to build optimization models for recommending partners in the GHG marketplace (e.g., a network of partners of the SCM company) based on current reported GHG emissions report of partners that best achieve a GHG emission reduction target of the company (or the network managed by the SCM company). In some aspects, the method or apparatus may enable a company (or the SCM company) to build optimization models of recommended partners in the GHG network (or the network of partners of the SCM company) that best achieve target GHG emission reduction of the company (or the SCM company) based on different partners' commitments to the company (or the SCM company) for offsetting carbon emissions based on purchasing carbon credits. Additionally, if a partner is accepted then the method or apparatus may, in some aspects, enable the carbon credits to be locked and/or escrowed.

In some aspects, the method or apparatus may provide an optimization model for recommending partners in the GHG marketplace. The optimization model, in some aspects, may be based on current reported GHG emissions from the GHG market participants. In contrast to the company-based optimization described above, the optimization, in some aspects, may be a global optimization that attempts to optimize one or more values for the GHG marketplace as a whole. The global optimization may produce different results than a set of local optimizations for the different market participants. The global optimization may include a set of recommendations for carbon credit purchases/sales to optimize a total GHG production based on the objectives defined by the different market participants.

In some aspects, system, method, and/or apparatus (e.g., a Green Supply Chain Partner Recommendation system) in accordance with some aspects of this disclosure may provide a method to recommend partners that minimizes or achieves a target Total GHG/Carbon Footprint (TGF) for a project and/or a time period. The system, method, and/or apparatus, in some aspects may enable the onboarding of SC partners to share non-repudiated and/or validated environmental qualitative and/or quantitative data that is trackable and/or traceable. The system, method, and/or apparatus, in some aspects may provide a single truth (a shared view of a GHG marketplace) and evidence-based tracking of environmental activities among SC partners. Automation of SC partner selection and policy implementation for carbon emission reductions using smart contracts may be provided in some aspects by the system, method, and/or apparatus. Additionally, the system, method, and/or apparatus may recommend ways to reduce emissions and use carbon offsets by carbon credits at the level of supply chain partners.

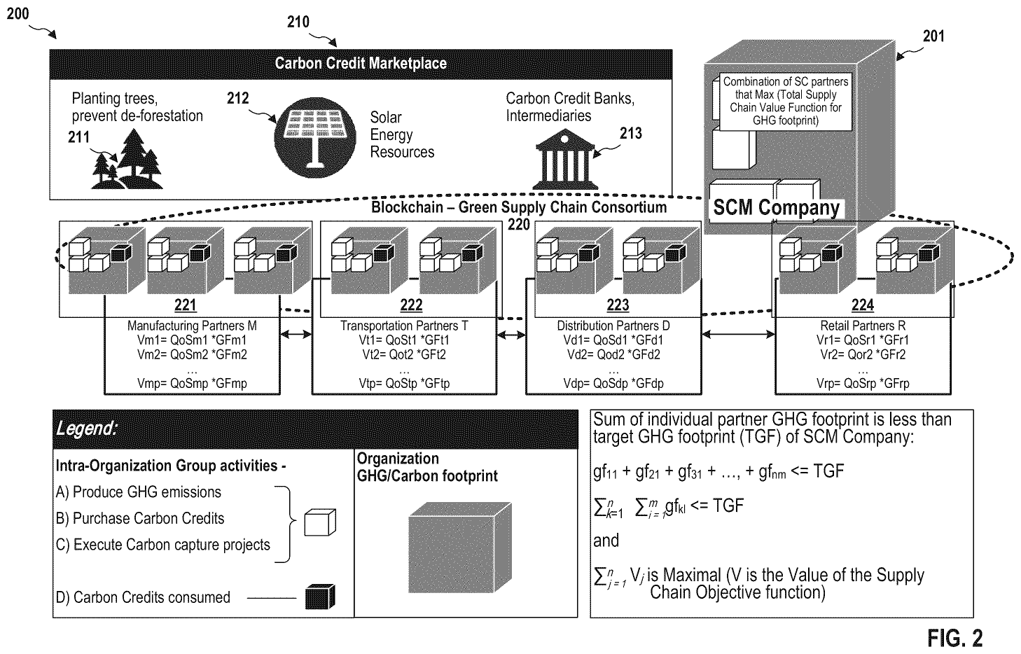

FIG. 2 is a diagram 200 illustrating a set of stakeholders in a GHG marketplace. The set of stakeholders, in some aspects, may include a SCM company 201, a set of carbon credit producers/intermediaries 210 (e.g., including a reforestation project 211, a green energy project 212, and a carbon credit bank/intermediary 213) and a set of GHG market participants 220 (e.g., members of a blockchain green supply chain consortium or potential partners). The GHG market participants 220 may include a set of manufacturers 221 (e.g., potential manufacturing partners), a set of transportation partners 222 (e.g., potential transportation partners), a set of distribution partners 223 (e.g., potential distribution partners), and a set of retail partners 224 (e.g., potential manufacturing partners). Each market participant of the GHG market participants 220 may be associated with a value computed based on a quality of service (QoS) and a GHG footprint (GF) (e.g., V_{i,j}=QoS_{i,j}*GF_{i,j}, for each group of partners, i, and each potential partner, j, within the group) used to calculate a value associated with a set of partners selected for a particular objective.

For example, the SCM company 201 may determine a target GF (TGF) for the supply chain (e.g., the sum of the partners GHG footprint in the SCM company's supply chain). The SCM company may then perform a selection based on the optimized allocation process that will be described below to select a set of partners for a specific project or time period. For the set of [symbol] given selections to be made, [symbol] ={1, . . . N} in [symbol] set of dimensions for the selections [symbol] ={1, . . . , M} i.e., the options for each manufacturer/transporter/warehouser and other partners on the supply chain. The objective to select the right portfolio of these partners to minimize carbon emission impact and maximize the value of the operations given that the capacity on these M dimensions is represented by the weighted value unit [symbol] ⱼ, j∈ [symbol] & the value function [symbol] i, i∈ [symbol] and weight ( [symbol] ᵢⱼ) of the i^{th} element in j^{th} dimension. Thus, the supply chain decision problem is represented as multidimensional knapsack problem given by,

$$Maximum of function f = {\sum }_{i ∈} {v}_{i} {x}_{i}$$

$$Subject to knapsack regular constraint {\sum }_{i ∈} {w}_{ij} {x}_{i} \leq {W}_{j} ∀ j ∈ ,$$

with xᵢ∈{0,1}, ∀i∈ [symbol] , and where the function ƒ may denote the value of the stakeholder/partner (options manufacture, transportation company, warehouse) to the supply chain and xᵢ is the allocation metric. For example, if an order is allocated to the i^{th} partner then the value of xᵢ may be determined to be 1. If the order is not allocated (or assigned) to the i^{th} partner the value of xᵢ may be determined (or assigned) to be 0. The function ƒ which provides the supply chain value, in some aspects, may be derived as the sum of the value provided by all the participating partners in the ecosystem. The value factor is determined based on a quality-of-service parameter assigned to each participant in the ecosystem based on the supply chain service request that been handled.

In some aspects, the selection and/or optimization process may be based on the objectives and constraints of the individual (potential) partners and the objectives and constraints of the SCM company. Information used to quantify the objectives and constraints (e.g., GHG emissions estimates, offset commitment, and other parameters for a partner recommendation for a specific project and/or time period), in some aspects, may be extracted from multi-blockchains providing a single truth, e.g., an SCM-company-operated GHG accounting blockchain, an SCM-company-operated carbon offset commitment blockchain, or third party operated mandatory and/or statutory GHG emissions reporting blockchain.

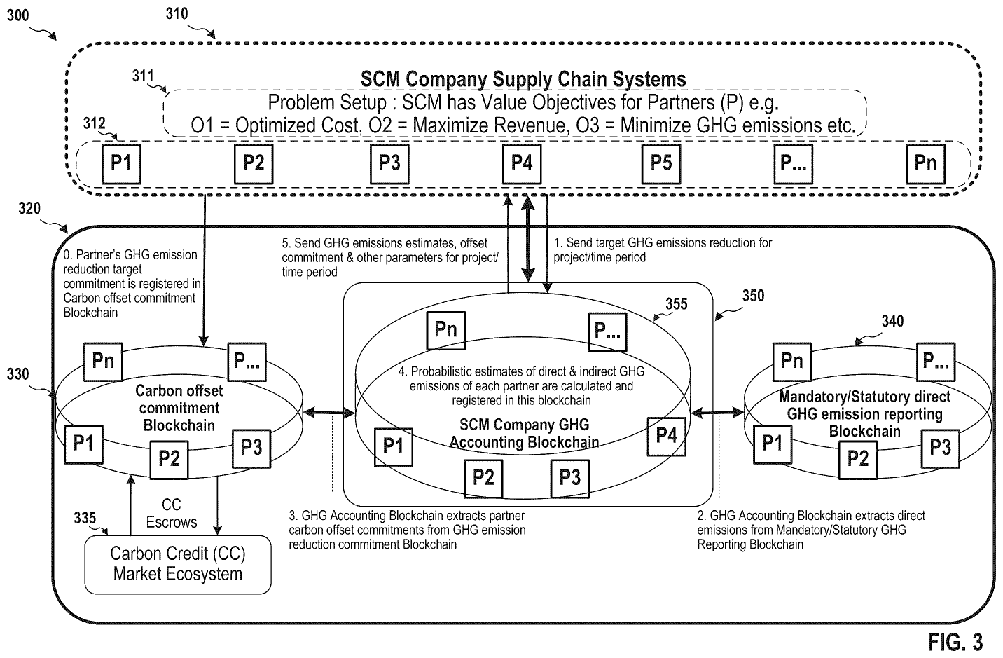

FIG. 3 is a diagram 300 illustrating components of a system for recommending partners for a SCM company in accordance with some aspects of the disclosure. The system may include a SCM company 310 that may be associated with one or more “problems” to be solved (e.g., one or more projects and/or time periods for which to select an optimized set of partners). Each problem may be associated with a set of parameters 311 and one or more of the potential partners, P₁ to P_{N}, in a set of potential partners 312. For example, the set of parameters 311, in some aspects, may include a set of objectives (e.g., optimizing cost, maximizing revenue, and minimizing GHG emissions, maximizing profit, or other value for optimization). Each objective may be associated with a relative weight indicating the relative importance of each objective or with a position in a hierarchy of objectives. The set of potential partners 312, in some aspects, may further be broken up into sub-groups of potential partners of a same type (e.g., manufacturing partners, transportation partners, distribution partners, retail partners, or other relevant types of partners). The SCM company 310, in some aspects, may interact with a GHG marketplace 320 providing a consistent view of the state of the market for GHG emissions, credits, commitments, and other relevant parameters for selecting and/or recommending partners based on a set of parameters (e.g., parameters 311).

The GHG marketplace 320, in some aspects, may be a multi-blockchain system providing a consistent (e.g., single truth) view of the state of the market. For example, the GHG marketplace may include a carbon offset commitment blockchain 330. The carbon offset commitment blockchain 330 may include information regarding a GHG emission reduction target for a set of potential partners as they are generated and/or registered with the carbon offset commitment blockchain 330. The carbon offset commitment blockchain 330, in some aspects, may also obtain information regarding carbon credits that have been purchased or acquired through a carbon credit (CC) market ecosystem 335. The CCs purchased or acquired by each partner may be “locked in” or escrowed by inclusion in the carbon offset commitment blockchain 330.

The GHG marketplace 320, in some aspects, may include a GHG emission reporting blockchain 340. The GHG emission reporting blockchain 340 may be associated with a statutory framework and/or an administrative (certification) or governmental agency mandating GHG emission reporting in some aspects. The GHG emission reporting blockchain 340 may include reported GHG emissions that represent measured and/or expected values for GHG emissions associated with different projects or time periods. The information in the carbon offset commitment blockchain 330 and the GHG emission reporting blockchain 340 may be accessed and/or obtained by an SCM partner recommendation and enforcement engine 350. The SCM partner recommendation and enforcement engine 350, in some aspects, may also obtain the parameters (e.g., parameters 311 and an associated set of potential partners 312) associated with one or more problems to be solved from the SCM company 310. The SCM partner recommendation and enforcement engine 350 may then use the information obtained from the SCM company 310, the carbon offset commitment blockchain 330, and the GHG emission reporting blockchain 340 to produce a recommendation for the SCM company. The SCM company 310 may then select a set of partners (including identifying how much of a service or product the partner is requested to provide) recommended to best achieve target GHG emission reduction and provide the selection to the GHG accounting blockchain 355 associated with the SCM company 310 to generate and/or record an agreement between the SCM company and the selected partners. In some aspects, the selection of the partners may be followed by a confirmation that each partner agrees to provide the requested volume of the service or product. In some aspects, a “smart contract” may be employed such that a contract and/or agreement with each partner to fulfill their part of the transaction is contingent on each partner entering into a related contract based on the recommendation and/or selection of the partners. A smart contract, in some aspects, provides a guarantee that if a particular partner does not agree to their part of the recommended transaction, the smart contract (or related smart contracts for other partners/parties) associated with the recommended transaction will not be executed for other partners/parties that may have agreed to, or accepted, the recommendation. Accordingly, the different agreements associated with the smart contract, or recommended transaction, will not be binding on any partner/party unless all partners/parties agree to be bound (e.g., accept the recommendation) such that no partner/party is bound by an agreement that no longer satisfies a desired outcome associated with the smart contract or recommended transaction.

Once the partners have agreed to the set of transactions and/or agreements associated with the recommendation and/or selection the set of transactions and/or agreements may be recorded in the GHG accounting blockchain 355. The GHG accounting blockchain 355, in some aspects, may further provide an indication of the nature of the transactions and/or agreements to one or more of the carbon offset commitment blockchain 330 or the GHG emission reporting blockchain 340 to update the state of the GHG marketplace 320. For example, the carbon offset commitment blockchain 330 may be provided information regarding new commitments associated with the new transactions and/or agreements. While the GHG marketplace 320 is discussed above in the context of a multi-blockchain example, it is understood that any secure and reliable system for recording transactions and/or agreements and monitoring their fulfillment may be used to implement the components of the GHG marketplace 320.

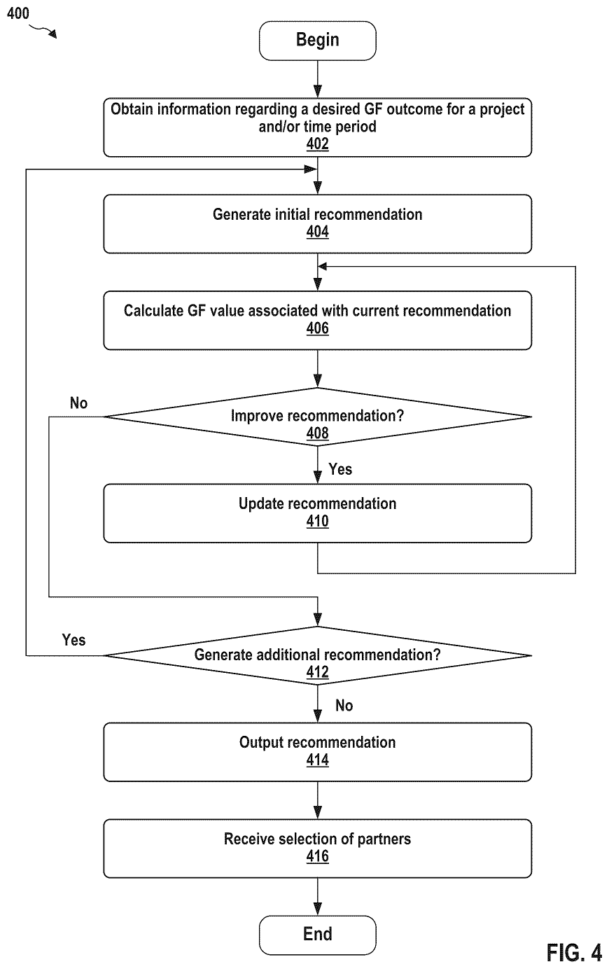

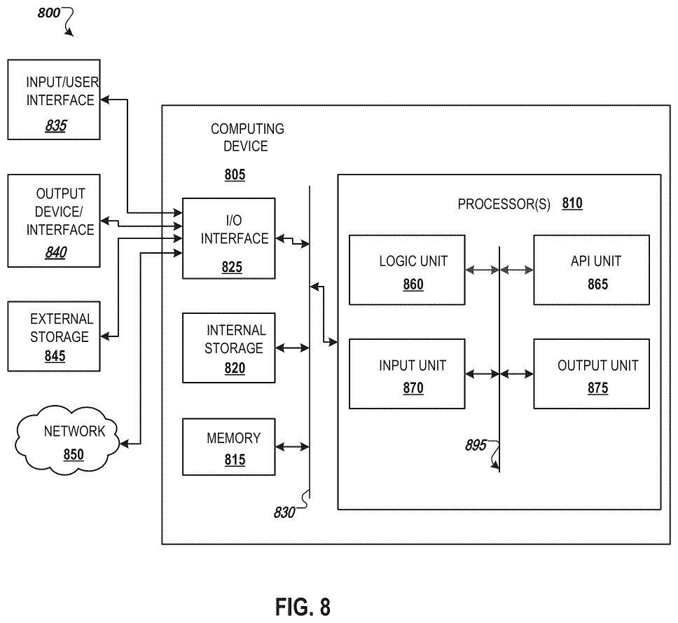

FIG. 4 is a flow diagram 400 illustrating a method in accordance with some aspects of the disclosure. In some aspects, the method is performed by an analysis apparatus (e.g., SCM partner recommendation and enforcement engine 350 or computing device 805) or system (e.g., a system including components associated with one or more SCM companies such as SCM company 310 and additional components of the GHG marketplace 320) that performs various analyses of information associated with a GHG marketplace and produces at least one recommended set of partners for a project and/or time period. At 402, the apparatus (or system) may obtain information (e.g., the set of parameters 311) regarding a desired target GF outcome for a project and/or a time period from SCM Company 310. For example, 402 may be performed by a component associated with the SCM company 310 for collecting the set of parameters 311 and/or an associated set of potential partners 312 or SCM partner recommendation and enforcement engine 350 of FIG. 3, or I/O interface 825 (or input/user interface 835) of FIG. 8. The information obtained, at 402, may include a set of parameters, a set of potential partners, a set of carbon offset commitments, a set of reported emissions, or other relevant information for calculating values associated with the project and/or time period. For example, referring to FIG. 3, the SCM partner recommendation and enforcement engine 350 may obtain, for a particular project and/or time period, the set of parameters 311, the set of potential partners 312, information regarding the set of carbon offset commitments from the carbon offset commitment blockchain 330, and information regarding a set of reported GHG emissions from the GHG emission reporting blockchain 340.

At 404, the apparatus may generate an initial recommendation of a set of partners and a set of weights associated with the selected set of partners. For example, 404 may be performed by SCM partner recommendation and enforcement engine 350 or processors 810 of computing device 805 of FIGS. 3 and 8, respectively. The initial recommendation, in some aspects, may be based on a random selection of partners and a random selection of weights associated with the selected partners. The recommendation may include a set of N potential partners (e.g., potential partner options based on the qualified service provider for the selected functional requirement) associated with a set of M types of potential partners (options based on operational or functional requirements). For example, for a set of N (e.g., 10) potential partners distributed among M (e.g., 4) different types of partners (e.g., a first manufacturing type (3 options), a second transportation type (4 options), a third distribution type (2 options), and a fourth retailer type (1 option)) the recommendation engine may provide a set of weights [{U_{1,1}, U_{1,2}, U_{1,3}, }; {U_{2,4}, U_{2,5}, U_{2,6}, U_{2,7}}; {U_{3,8}, U_{3,9}}; {U_{4,10}}] with U_{k,1} representing the weight for the l^{th} element in the set of N potential partners associated with the k^{th} type of partner. Each U may take a value between 0 and 1 indicating a portion of the service and/or products associated with the partner.

At 406, the apparatus may calculate a GF value function associated with the current recommendation (e.g., the current set of recommended partners and the associated weights). For example, 406 may be performed by SCM partner recommendation and enforcement engine 350 or processors 810 of computing device 805 of FIGS. 3 and 8, respectively. A GF value function (e.g., Vᵢ) calculated at 406 may be based on a decision (or quality of service) variable, αᵢ, indicating a quality of service (or product) provided by the partner (where αᵢ is the decision variable accounting for the amount of service that is fulfilled by an i^{th} provider in the set of N providers). The variable αᵢ, in some aspects, is a qualitative metric that is used to quantify the level of service provided by a partner in the supply chain ecosystem. In some aspects, αᵢ may not be an absolute metric, and may represent a relative score that may be offered based on the type of service provided by the i^{th} partner. The GF value function (e.g., Vᵢ) calculated at 406 may further be based on a second factor, ϑᵢ, where (0<ϑ<1) indicating the GHG and/or carbon footprint ratio incurred by the partner in a quality dimension. In some aspects, the decision variable is based on the weight U_{k,l} and the second factor may be obtained from a GHG emission reporting blockchain (or other source for reported emission data). The first factor, in some aspects, may represent a calculated value based on a plurality of criteria and/or quality dimensions such that the importance of each criteria and/or dimension of quality is reflected in the first factor. For example, a GF value may be calculated by

$${V}_{i} = {\sum }_{i = 1}^{N} {α}_{i} * {ϑ}_{i} .$$

Additionally, the apparatus may, at 406, calculate a weight value Wⱼ for j∈M associated with each dimension and/or partner type (e.g., by

$${W}_{j} = {\sum }_{i = 1}^{N} {w}_{j , i} * {x}_{i} ,$$

where w_{j,i} is a weight associated with a potential partner, i, in the j^{th} group and xᵢ is a binary value indicating whether the potential partner is selected).

At 408, the apparatus may determine whether to attempt to improve a current recommendation. For example, 408 may be performed by SCM partner recommendation and enforcement engine 350 or processors 810 of computing device 805 of FIGS. 3 and 8, respectively. In some aspects, the apparatus may calculate a solution estimate

$$π = {\sum }_{i = 1}^{N} {v}_{i} * {x}_{i} - {W}_{j} ,$$

where vᵢ is related to the value function evaluated based on the allowable GHG emission based on the requirement of the SCM. The solution estimate, π, may be used, in some aspects, to determine whether an improved recommendation is possible and/or likely. In some aspects, if the calculated solution estimate, π, is less than 0, the apparatus may determine to attempt to improve the current recommendation.

In some aspects, Wⱼ represents the operational capacities of the partners in the supply chain. For example, to fill an order for 10 units with an associated manufacturing process that takes 15 hours, w_{i,j} may represent the portion of the 15 hours assigned, or distributed, to the i^{th} option available in a corresponding supply chain registry. In some aspects, the distribution of hours decision is made based on the manufacturer's capacity to handle additional hours. The solution estimation function, in some aspects, provides the final order allocation. For example, if the total number of allocations from the algorithm

$${\sum }_{i = 1}^{N} {v}_{i} * {x}_{i}$$

is greater than Wⱼ then it implies that the total allocation is greater than the requested allocation and hence the solution is termed infeasible.

After determining to attempt to improve the current recommendation, the apparatus may update the recommendation at 410. For example, 410 may be performed by SCM partner recommendation and enforcement engine 350 or processors 810 of computing device 805 of FIGS. 3 and 8, respectively. Updating the recommendation at 410, in some aspects, may include searching global optimal solution or nearest best possible solution sets. The optimal solution is recommended to the participants in the SCM blockchain for weighted value allocation units and confirmation of order release if later established via blockchain. A solution set (e.g., an updated recommendation) determined and/or identified by searching the global and nearest and nearest best possible solution sets may then be provided as an input to a probability learning operation and/or process. The probability learning operation and/or process may apply rules to estimate marginal and joint probability distributions for the updated recommendation. The apparatus may then sample for partner sets based on the probability table results (marginal and joint probability distribution table evaluated from previous step) from the probabilistic learning operation and/or process to identify a recommendation (e.g., a partner with a highest-ranking probability distribution on the table may be identified, and sampled, for a recommendation) used to update the recommendation at 410. For example, a current recommendation [{U_{1,1}, U_{1,2}, U_{1,3},}; {U_{2,4}, U_{2,5}, U_{2,6}, U_{2,7}}; {U_{3,8}, U_{3,9}}; {U_{4,10}}] may be updated to [{U′_{1,1}, U′_{1,2}, U′_{1,3},}; {U′_{2,4}, U′_{2,5}, U′_{2,6}, U′_{2,7}}; {U′_{3,8}, U′_{3,9}}; {U′_{4,10}}] based on the search, probability learning, and sampling operations. The apparatus may then return to 406 to calculate, e.g., the GF value and the weight.

However, if the apparatus determines at 408 to not improve the recommendation (e.g., if the calculated solution estimate, π, is greater than 0), the apparatus may determine, at 412, whether to generate an additional recommendation. If the apparatus determines, at 412, to generate an additional recommendation, the apparatus may return to 404 to generate another initial (e.g., randomized) recommendation for refinement as described above. If the apparatus determines, at 412, to not generate an additional recommendation, the apparatus may output, at 414, the set of recommendations may be output to a user (e.g., an administrator associated with an SCM company). For example, 414 may be performed by SCM partner recommendation and enforcement engine 350 or processors 810, I/O interface 825, output device/interface 840, and/or network 850 of computing device 805 of FIGS. 3 and 8, respectively. Based on the recommendations output at 414, the apparatus may receive a selection of a particular recommendation to be used and the process may end.

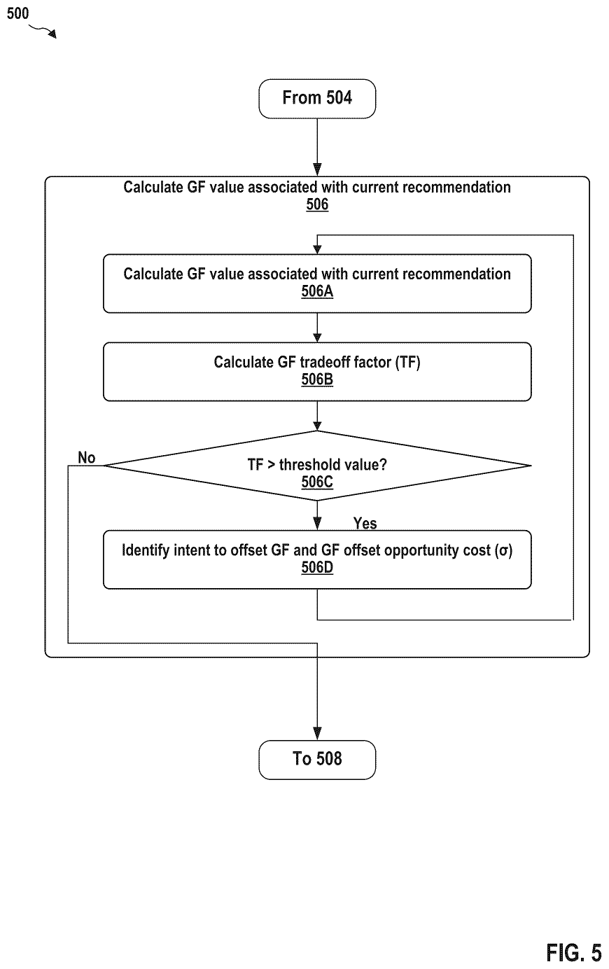

In some aspects, the method illustrated in FIG. 4 may produce a set of recommendations that are a set of first pass recommendations that may be further refined based on a consideration of the partners' intent to offset GF using carbon credits. FIG. 5 is a flow diagram 500 illustrating a set of operations for a second pass calculation of a GF value associated with a current recommendation at 506 that is further based on the use of carbon credits. For example, 606A may be performed by SCM partner recommendation and enforcement engine 350 or processors 810 of computing device 805 of FIGS. 3 and 8, respectively. The second pass calculation of the GF value at 506 may begin at 606a by calculating a GF value based on the decision variable, αᵢ, indicating an amount of service (or product) provided by the partner, i, the second factor, ϑᵢ, indicating the GHG and/or carbon footprint ratio incurred by the partner in a quality dimension, and a third factor, σᵢ, associated with a carbon offset purchased by the partner. The third factor, in some aspects, may be obtained from a carbon offset commitment blockchain (or other source for carbon offset data). In some aspects, a first calculation of a GF value for a particular recommendation may have the set of third factors set to zero before obtaining information regarding carbon offsets as described below in relation to an identification operation at 606D below. For example, a GF value may be calculated by

$${V}_{i} = {\sum }_{i = 1}^{N} {α}_{i} * ( {ϑ}_{i} + {σ}_{i} ) .$$

Additionally, the apparatus may, at 606A, calculate the weight value Wⱼ associated with each dimension and/or partner type as described in relation to 406 of FIG. 4.

After calculating the GF value at 606A, the apparatus may calculate a GF tradeoff factor (TF) at 606B. For example, 606B may be performed by SCM partner recommendation and enforcement engine 350 or processors 810 of computing device 805 of FIGS. 3 and 8, respectively. The TF, in some aspects, may be based on the GF value and the decision value. For example, in some aspects, the TF may be calculated using the equation by

$$TF = {\sum }_{i = 1}^{N} {α}_{i} / {\sum }_{i = 1}^{N} {α}_{i} * {ϑ}_{i} .$$

The TF may be used to evaluate the desirability of one or more carbon credit purchases and a distribution of the carbon credit purchases across the supply chain. In some aspects, the TF may be associated with a condition and/or threshold value. For example, a TF may be associated with a conditional statement (e.g., TF≤1) such that a first action and/or decision is associated with a FALSE result (e.g., TF>1, or TF≤1=FALSE) and a second action and/or decision is associated with a TRUE result (e.g., TF≤1, or TF≤1=TRUE). The TF (or the result of the conditional statement associated with the TF), in some aspects, may guide a carbon credit purchase decision and indicate a quantity of CCs to purchase based on the variable and fixed opportunity cost incurred by one or more partners. In some aspects, the TF indicates the extent to which the supply chain's value function is impacted by the carbon-footprint-based penalization determined by the allocation algorithm.

At 606C, the apparatus may determine whether the TF calculated at 606B is above a threshold value. For example, 606C may be performed by SCM partner recommendation and enforcement engine 350 or processors 810 of computing device 805 of FIGS. 3 and 8, respectively. The threshold value for the TF, in some aspects, may be one of the parameters obtained at 402 of FIG. 4. The TF threshold, in some aspects, may indicate an acceptable level of GF from a particular partner compared to a target GF calculated for the current recommendation (e.g., a target GF of the SCM Company's associated supply chain network with the current recommendation). If the apparatus, at 606C determines that the TF calculated at 606B is above the threshold, the apparatus may identify, at 606D, an intent by one or more partners to purchase and/or invest in a carbon offset (e.g., a CC, or GF offset) and an opportunity cost, σᵢ, associated with the carbon offset intended to be purchased by a partner, i. The opportunity costs for each partner may then be used to calculate a GF value that considers the purchased carbon offsets (e.g., considers the σᵢ) as described above in relation to the calculation of the GF value at 606A. If the apparatus, at 606C determines that the TF calculated at 606B is below the threshold, the apparatus may proceed to determine whether to attempt to improve a current recommendation at 408.

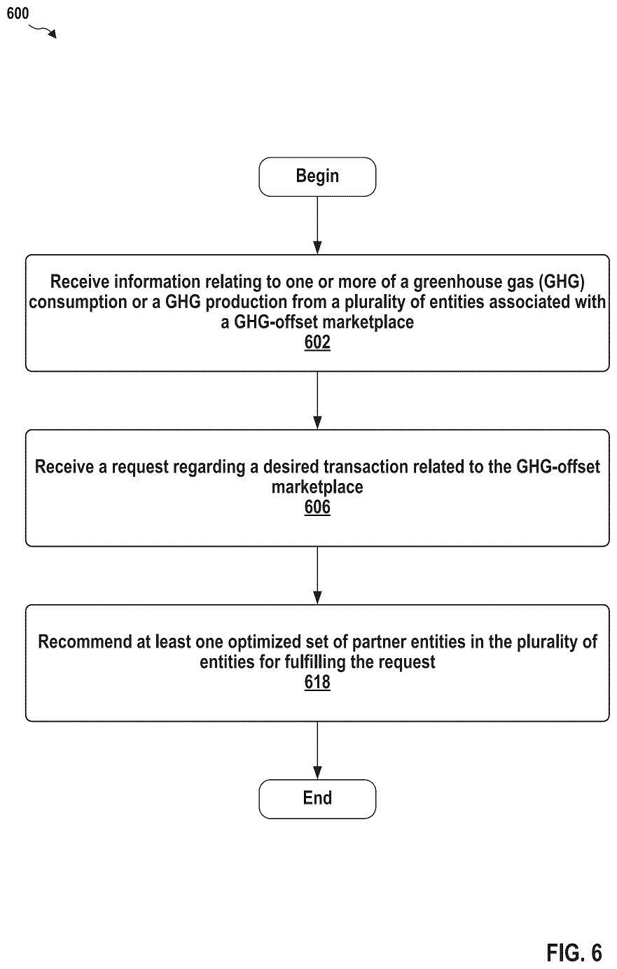

FIG. 6 is a flow diagram 600 illustrating a method in accordance with some aspects of the disclosure. In some aspects, the method is performed by an analysis apparatus (e.g., SCM partner recommendation and enforcement engine 350 or computing device 805) that performs various analyses of information associated with a GHG marketplace and produces at least one recommended set of partners for a project and/or time period. At 602, the apparatus may obtain information relating to one or more of a GHG consumption or a GHG production associated with a plurality of entities associated with a GHG-offset marketplace. For example, 602 may be performed by SCM partner recommendation and enforcement engine 350 or I/O interface 825 of computing device 805 of FIGS. 3 and 8, respectively. The information obtained at 602, in some aspects, may include, for each of the plurality of entities (e.g., potential partners), information regarding one or more of an identity of the partner, the type of partner (e.g., manufacturing, transportation, distribution, retail, and so on), a reported GHG emission (production), a set of carbon offset purchases, or a set of characteristics of the partner (e.g., desired GF, a capacity, a set of GF characteristics, GF criteria, and so on). For example, referring to FIGS. 3 and 5, the SCM partner recommendation and enforcement engine 350 may obtain, at 402, information from the SCM company 310, the carbon offset commitment blockchain 330, and/or the GHG emission reporting blockchain 340 regarding the potential partners such as a current set of commitments and a set of reported GHG emissions/offsets for each partner or a set of projects and/or time periods associated with each partner.

Based on the information relating to the one or more of the GHG consumption or the GHG production obtained at 602, the apparatus may generate a model representing a unified GHG marketplace. The generated model, in some aspects, may include (1) a first set of data relating to a set of commitments made by a set of entities in the plurality of entities, (2) a second set of data relating to monitoring whether each particular entity in the set of entities is meeting a subset of the set of commitments associated with the particular entity, and (3) a third set of data used related to predicting one of GHG production or GHG consumption for each entity in the plurality of entities, wherein the third set of data is based on at least one of the first set of data and the second set of data. For example, referring to FIG. 3, the SCM partner recommendation and enforcement engine 350 may generate a model of the GHG marketplace based on the information obtained from the SCM company 310, the carbon offset commitment blockchain 330, and/or the GHG emission reporting blockchain 340.

At 606, the apparatus may receive a request regarding a desired transaction related to the GHG-offset marketplace. For example, 606 may be performed by SCM partner recommendation and enforcement engine 350 or I/O interface 825 of computing device 805 of FIGS. 3 and 8, respectively. The request received at 606, in some aspects, may indicate a target GHG emission parameter associated with a desired GHG offset or GHG footprint target for a project and/or time period associated with the request. In some aspects, the request received at 606 may relate to a supply chain activity associated with one or more of a product, a project, an enterprise, or a service. The request received at 606, in some aspects, may further include parameters for desired GFs for individual potential partners. For example, referring to FIG. 3, the SCM partner recommendation and enforcement engine 350 may receive a request from SCM company 310 regarding a project and/or time period associated with a desired project. The request, in some aspects, may include parameters (e.g., parameters 311 and an associated set of potential partners 312) associated with one or more problems to be solved.

Based on the request received at 606, the apparatus may evaluate an objective function based on a set of reported GFs of candidate partner entities in the plurality of entities. The evaluation, in some aspects, may be considered a first step in an optimization of the objective function (e.g., by optimizing a set of recommended partners that forms the basis for the evaluation). The objective function, in some aspects, may be designed to maximize a particular attribute (or a set of ordered and/or weighted attributes, according to an importance of the attributes) for a project (e.g., one or more of a GF, a profit, a cost, or other attribute). In some aspects, the evaluated value function may be based on a current recommendation. For a first evaluation associated with a request, the evaluation may be based on a randomly or algorithmically initialized recommendation.

As discussed above in relation to FIG. 4, the evaluation may be based on the first factor, αᵢ, relating to a QoS and/or a fraction of the particular service or product provided by each partner and a second factor, ϑᵢ, relating to a value of a contribution of each partner (e.g., a value indicating and/or representing the contribution of the partner to the attributes to be maximized). In some aspects, the first factor and the second factor may be sets of values (e.g., a first set of QoS values and a corresponding second set of contribution values). During a first pass, the evaluation at 608 may not consider attributes of CCs associated with the different partners, σᵢ, while subsequent passes (for a same recommendation or a different recommendation) may consider the attributes of CCs associated with the different partners as described in relation to 406 and 506 of FIGS. 4 and 6, respectively. Evaluating the objective function, in some aspects, may include evaluating a weight Wⱼ associated with the recommendation as discussed in relation to the calculation at 406 of FIG. 4 above. For example, referring to FIGS. 3-6, the SCM partner recommendation and enforcement engine 350 may calculate a GF value function at 406 and/or 506 based on the information obtained at 402.

In some aspects, during a second pass evaluation, the apparatus may compute a tradeoff factor and determine if the TF is above a threshold TF value. The TF, in some aspects, may be based on the GF value and the decision value. The TF, in some aspects, may be based on the GF value (e.g., the second factor) and the decision value (e.g., the first factor). The TF may be used, in some aspects to evaluate the desirability of one or more carbon credit purchases and a distribution of the carbon credit purchases across the supply chain. In some aspects, the TF may guide a carbon credit purchase decision and indicate a quantity of CCs to purchase based on the variable and fixed opportunity cost incurred by one or more partners. The threshold value for the TF, in some aspects, may be one of the parameters received as part of the request at 606. The TF threshold, in some aspects, may indicate an acceptable level of GF from a particular partner compared to a target GF calculated for the current recommendation (e.g., a target GF of the SCM Company's associated supply chain network with the current recommendation). For example, referring to FIGS. 3 and 6, the SCM partner recommendation and enforcement engine 350 may calculate a TF at 606B and determine whether it is above a threshold value at 606C.

If the apparatus determines that the calculated TF is above the threshold, the apparatus may proceed to obtain data for at least one candidate partner entity regarding a potential GF offset by the at least one candidate partner entity. The data obtained, in some aspects, may be obtained from a carbon offset commitment blockchain (or other data structure storing information regarding a carbon offset market). The data obtained, in some aspects, may indicate an intent by one or more partners to purchase and/or invest in a carbon offset (e.g., a CC, or GF offset) and an opportunity cost, oi, associated with the carbon offset intended to be purchased by a partner, i. The apparatus may then return to evaluate the objective function based on data obtained (e.g., a set of opportunity costs for each partner). For example, referring to FIGS. 3 and 6, the SCM partner recommendation and enforcement engine 350 may determine that a TF value is above a threshold value at 606C and proceed to 606D to identify an intent by one or more partners to purchase and/or invest in a carbon offset (e.g., a CC, or GF offset) and an opportunity cost, σᵢ, associated with the carbon offset intended to be purchased by a partner, i.

In some aspect, if the apparatus, determines that the calculated TF is below the threshold, the apparatus may proceed to determine whether a different set of candidate partner entities may improve the objective function. In some aspects, the apparatus may calculate a solution estimate

$$π = {\sum }_{i = 1}^{N} {v}_{i} * {x}_{i} - {W}_{j}$$

that may be used to determine whether an improved recommendation is possible and/or likely to exist. In some aspects, if the calculated solution estimate, π, is less than 0, the apparatus may determine to attempt to improve the current recommendation. For example, referring to FIGS. 3 and 5, the SCM partner recommendation and enforcement engine 350 may determine, at 408, whether to attempt to improve a current recommendation.

After determining to attempt to improve the current recommendation, the apparatus, in some aspects, may select an updated set of candidate partner entities. Updating the recommendation, in some aspects, may include searching global and nearest best possible solution sets. A solution set (e.g., an updated recommendation) determined and/or identified by searching the global and nearest and nearest best possible solution sets may then be provided as an input to a probability learning operation and/or process. The probability learning operation and/or process may apply rules to estimate marginal and joint probability distributions for the updated recommendation. The apparatus may then sample for partner sets based on the probability table results from the probability learning operation and/or process to identify a recommendation used to update the recommendation. For example, a current recommendation [{U_{1,1}, U_{1,2}, U_{1,3},}; {U_{2,4}, U_{2,5}, U_{2,6}, U_{2,7}}; {U_{3,8}, U_{3,9}}; {U_{4,10}}] may be updated to [{U′_{1,1}, U′_{1,2}, U′_{1,3},}; {U′_{2,4}, U′_{2,5}, U′_{2,6}, U′_{2,7}}; {U′_{3,9}, U′_{3,9}}; {U_{4,10}}] based on the search, probability learning, and sampling operations. The apparatus may then return to evaluate the recommendation, e.g., to evaluate the GF value and the weight associated with the updated recommendation. For example, referring to FIGS. 3-6, the SCM partner recommendation and enforcement engine 350 may determine, at 408, to attempt to improve a current recommendation, proceed to update the recommendation at 410, and provide the updated recommendation for an additional calculation of the GF value associated with the updated recommendation at 406 and/or 606A.

However, if the apparatus determines to not improve the recommendation (e.g., if the calculated solution estimate, π, is greater than 0), the apparatus may recommend, at 618, at least one optimized set of partner entities in the plurality of entities for fulfilling the request based on the request and the information relating to the one or more of the GHG consumption or the GHG production. In some aspects, the set of recommendations may be output, at 618, to a user (e.g., an administrator associated with an SCM company). For example, 618 may be performed by SCM partner recommendation and enforcement engine 350 of FIG. 3 or processors 810, I/O interface 825, output device/interface 840, and/or network 850 of computing device 805 of FIG. 8. For example, referring to FIGS. 3 and 5, the SCM partner recommendation and enforcement engine 350 may determine, at 408, to not attempt to improve a current recommendation and proceed to output the recommendation at 414.

Based on the recommendations, the apparatus may receive a selection of partner entities associated with a first optimized set of partner entities in the at least one optimized set of partner entities. The selection, in some aspects, may be associated with a set of contractual obligations (e.g., via a smart, or blockchain-based, contract) for each of the partners associated with the selected first set of optimized partner entities. Accordingly, the apparatus may provide a set of carbon credit commitments related to the selection of the partner entities to update the information relating to the one or more of the GHG consumption or the GHG production associated with the GHG-offset marketplace. For example, referring to FIG. 3, the SCM partner recommendation and enforcement engine 350 may receive, at 416, a selection of a particular set of partners output at 414 from SCM company 310 regarding a project and/or time period associated with a desired project. The selection may then trigger a set of obligations for the selected partners and or predicted GHG emissions that are reported (or recorded) to update the carbon offset commitment blockchain 330, the GHG emission reporting blockchain 340, and/or the GHG marketplace 320 generally.

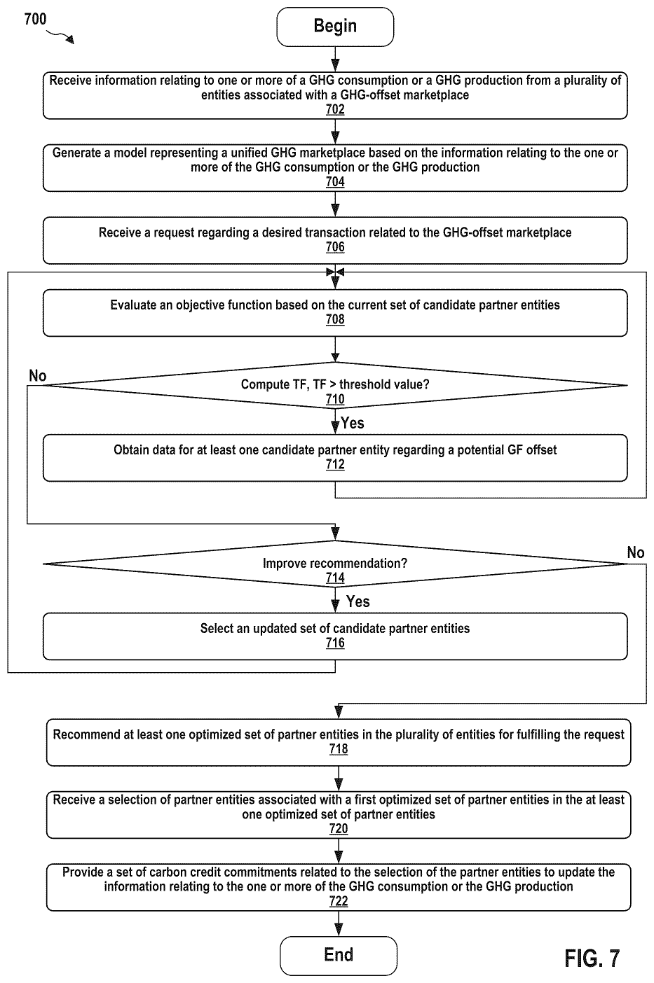

FIG. 7 is a flow diagram 700 illustrating a method in accordance with some aspects of the disclosure. In some aspects, the method is performed by an analysis apparatus (e.g., SCM partner recommendation and enforcement engine 350 or computing device 805) that performs various analyses of information associated with a GHG marketplace and produces at least one recommended set of partners for a project and/or time period. At 702, the apparatus may obtain information relating to one or more of a GHG consumption or a GHG production associated with a plurality of entities associated with a GHG-offset marketplace. For example, 702 may be performed by SCM partner recommendation and enforcement engine 350 or I/O interface 825 of computing device 805 of FIGS. 3 and 8, respectively. The information obtained at 702, in some aspects, may include, for each of the plurality of entities (e.g., potential partners), information regarding one or more of an identity of the partner, the type of partner (e.g., manufacturing, transportation, distribution, retail, and so on), a reported GHG emission (production), a set of carbon offset purchases, or a set of characteristics of the partner (e.g., desired GF, a capacity, a set of GF characteristics, GF criteria, and so on). For example, referring to FIGS. 3 and 5, the SCM partner recommendation and enforcement engine 350 may obtain, at 402, information from the SCM company 310, the carbon offset commitment blockchain 330, and/or the GHG emission reporting blockchain 340 regarding the potential partners such as a current set of commitments and a set of reported GHG emissions/offsets for each partner or a set of projects and/or time periods associated with each partner.

At 704, the apparatus may generate a model representing a unified GHG marketplace based on the information relating to the one or more of the GHG consumption or the GHG production obtained at 702. For example, 704 may be performed by SCM partner recommendation and enforcement engine 350 or processors 810 of computing device 805 of FIGS. 3 and 8, respectively. The model generated at 704, in some aspects, may include (1) a first set of data relating to a set of commitments made by a set of entities in the plurality of entities, (2) a second set of data relating to monitoring whether each particular entity in the set of entities is meeting a subset of the set of commitments associated with the particular entity, and (3) a third set of data used related to predicting one of GHG production or GHG consumption for each entity in the plurality of entities, wherein the third set of data is based on at least one of the first set of data and the second set of data. For example, referring to FIG. 3, the SCM partner recommendation and enforcement engine 350 may generate a model of the GHG marketplace based on the information obtained from the SCM company 310, the carbon offset commitment blockchain 330, and/or the GHG emission reporting blockchain 340.

At 706, the apparatus may receive a request regarding a desired transaction related to the GHG-offset marketplace. For example, 706 may be performed by SCM partner recommendation and enforcement engine 350 or I/O interface 825 of computing device 805 of FIGS. 3 and 8, respectively. The request received at 706, in some aspects, may indicate a target GHG emission parameter associated with a desired GHG offset or GHG footprint target for a project and/or time period associated with the request. In some aspects, the request received at 706 may relate to a supply chain activity associated with one or more of a product, a project, an enterprise, or a service. The request received at 706, in some aspects, may further include parameters for desired GFs for individual potential partners. For example, referring to FIG. 3, the SCM partner recommendation and enforcement engine 350 may receive a request from SCM company 310 regarding a project and/or time period associated with a desired project. The request, in some aspects, may include parameters (e.g., parameters 311 and an associated set of potential partners 312) associated with one or more problems to be solved.

Based on the request received at 706, the apparatus may evaluate, at 708, an objective function based on a set of reported GFs of candidate partner entities in the plurality of entities. For example, 708 may be performed by SCM partner recommendation and enforcement engine 350 or processors 810 of computing device 805 of FIGS. 3 and 8, respectively. The evaluation at 708, in some aspects, may be considered a first step in an optimization of the objective function (e.g., by optimizing a set of recommended partners that forms the basis for the evaluation). The objective function, in some aspects, may be designed to maximize a particular attribute (or a set of ordered and/or weighted attributes, according to an importance of the attributes) for a project (e.g., one or more of a GF, a profit, a cost, or other attribute). In some aspects, the evaluated value function may be based on a current recommendation. For a first evaluation associated with a request, the evaluation at 708 may be based on a randomly or algorithmically initialized recommendation.

As discussed above in relation to FIG. 4, the evaluation may be based on the first factor, αᵢ, relating to a QoS and/or a fraction of the particular service or product provided by each partner and a second factor, ϑᵢ, relating to a value of a contribution of each partner (e.g., a value indicating and/or representing the contribution of the partner to the attributes to be maximized). In some aspects, the first factor and the second factor may be sets of values (e.g., a first set of QoS values and a corresponding second set of contribution values). During a first pass, the evaluation at 708 may not consider attributes of CCs associated with the different partners, σᵢ, while subsequent passes (for a same recommendation or a different recommendation) may consider the attributes of CCs associated with the different partners as described in relation to 406 and 506 of FIGS. 4 and 6, respectively. Evaluating the objective function, in some aspects, may include evaluating a weight Wⱼ associated with the recommendation as discussed in relation to the calculation at 406 of FIG. 4 above. For example, referring to FIGS. 3-6, the SCM partner recommendation and enforcement engine 350 may calculate a GF value function at 406 and/or 506 based on the information obtained at 402.

At 710, the apparatus may compute a tradeoff factor and determine if the TF is above a threshold TF value. For example, 710 may be performed by SCM partner recommendation and enforcement engine 350 or processors 810 of computing device 805 of FIGS. 3 and 8, respectively. The TF, in some aspects, may be based on the GF value and the decision value. The TF, in some aspects, may be based on the GF value (e.g., the second factor) and the decision value (e.g., the first factor). The TF may be used, in some aspects to evaluate the desirability of one or more carbon credit purchases and a distribution of the carbon credit purchases across the supply chain. In some aspects, the TF may guide a carbon credit purchase decision and indicate a quantity of CCs to purchase based on the variable and fixed opportunity cost incurred by one or more partners. The threshold value for the TF, in some aspects, may be one of the parameters received as part of the request at 706. The TF threshold, in some aspects, may indicate an acceptable level of GF from a particular partner compared to a target GF calculated for the current recommendation (e.g., a target GF of the SCM Company's associated supply chain network with the current recommendation). For example, referring to FIGS. 3 and 6, the SCM partner recommendation and enforcement engine 350 may calculate a TF at 606B and determine whether it is above a threshold value at 606C.

If the apparatus, at 710, determines that the calculated TF is above the threshold, the apparatus may proceed to obtain, at 712, data for at least one candidate partner entity regarding a potential GF offset by the at least one candidate partner entity. For example, 712 may be performed by SCM partner recommendation and enforcement engine 350 of FIG. 3 or processors 810 or I/O interface 825 of computing device 805 of FIG. 8. The data obtained at 712, in some aspects, may be obtained from a carbon offset commitment blockchain (or other data structure storing information regarding a carbon offset market). The data obtained at 712, in some aspects, may indicate an intent by one or more partners to purchase and/or invest in a carbon offset (e.g., a CC, or GF offset) and an opportunity cost, σᵢ, associated with the carbon offset intended to be purchased by a partner, i. The apparatus may then return to evaluate, at 708, the objective function based on data obtained at 712 (e.g., a set of opportunity costs for each partner). For example, referring to FIGS. 3 and 6, the SCM partner recommendation and enforcement engine 350 may determine that a TF value is above a threshold value at 606C and proceed to 606D to identify an intent by one or more partners to purchase and/or invest in a carbon offset (e.g., a CC, or GF offset) and an opportunity cost, σᵢ, associated with the carbon offset intended to be purchased by a partner, i.

If the apparatus, at 710, determines that the calculated TF is below the threshold, the apparatus may proceed to determine, at 714, whether a different set of candidate partner entities may improve the objective function. For example, 714 may be performed by SCM partner recommendation and enforcement engine 350 or processors 810 of computing device 805 of FIGS. 3 and 8, respectively. In some aspects, the apparatus may calculate a solution estimate

$$π = {\sum }_{i = 1}^{N} {v}_{i} * {x}_{i} - {W}_{j}$$

that may be used to determine whether an improved recommendation is possible and/or likely to exist. In some aspects, if the calculated solution estimate, π, is less than 0, the apparatus may determine to attempt to improve the current recommendation at 714. For example, referring to FIGS. 3 and 5, the SCM partner recommendation and enforcement engine 350 may determine, at 408, whether to attempt to improve a current recommendation.

After determining to attempt to improve the current recommendation, the apparatus may select an updated set of candidate partner entities at 716. For example, 716 may be performed by SCM partner recommendation and enforcement engine 350 or processors 810 of computing device 805 of FIGS. 3 and 8, respectively. Updating the recommendation at 716, in some aspects, may include searching global and nearest best possible solution sets. A solution set (e.g., an updated recommendation) determined and/or identified by searching the global and nearest and nearest best possible solution sets may then be provided as an input to a probability learning operation and/or process. The probability learning operation and/or process may apply rules to estimate marginal and joint probability distributions for the updated recommendation. The apparatus may then sample for partner sets based on the probability table results from the probability learning operation and/or process to identify a recommendation used to update the recommendation at 716. For example, a current recommendation [{U_{1,1}, U_{1,2}, U_{1,3}}; {U_{2,4}, U_{2,5}, U_{2,6}, U_{2,7}}; {U_{3,8}, U_{3,9}}; {U_{4,10}}] may be updated to [{U′_{1,1}, U′_{1,2}, U′_{1,3},}; {U′_{2,4}, U′_{2,5}, U′_{2,6}, U′_{2,7}}; {U′_{3,8}, U′_{3,9}}; {U′_{4,10}}] based on the search, probability learning, and sampling operations. The apparatus may then return to 708 to evaluate the recommendation, e.g., to evaluate the GF value and the weight associated with the updated recommendation. For example, referring to FIGS. 3-6, the SCM partner recommendation and enforcement engine 350 may determine, at 408, to attempt to improve a current recommendation, proceed to update the recommendation at 410, and provide the updated recommendation for an additional calculation of the GF value associated with the updated recommendation at 406 and/or 606A.

However, if the apparatus determines, at 714, to not improve the recommendation (e.g., if the calculated solution estimate, π, is greater than 0), the apparatus may recommend, at 718, at least one optimized set of partner entities in the plurality of entities for fulfilling the request based on the request and the information relating to the one or more of the GHG consumption or the GHG production. In some aspects, the set of recommendations may be output, at 718, to a user (e.g., an administrator associated with an SCM company). For example, 718 may be performed by SCM partner recommendation and enforcement engine 350 of FIG. 3 or processors 810, I/O interface 825, output device/interface 840, and/or network 850 of computing device 805 of FIG. 8. For example, referring to FIGS. 3 and 5, the SCM partner recommendation and enforcement engine 350 may determine, at 408, to not attempt to improve a current recommendation and proceed to output the recommendation at 414.

Based on the recommendations output at 718, the apparatus may receive, at 720, a selection of partner entities associated with a first optimized set of partner entities in the at least one optimized set of partner entities. For example, 720 may be performed by SCM partner recommendation and enforcement engine 350 of FIG. 3 or processors 810, I/O interface 825, input/user interface 835, and/or network 850 of computing device 805 of FIG. 8. The selection, in some aspects, may be associated with a set of contractual obligations (e.g., via a smart, or blockchain-based, contract) for each of the partners associated with the selected first set of optimized partner entities.

Accordingly, the apparatus, at 722, may provide a set of carbon credit commitments related to the selection of the partner entities to update the information relating to the one or more of the GHG consumption or the GHG production associated with the GHG-offset marketplace. For example, referring to FIG. 3, the SCM partner recommendation and enforcement engine 350 may receive, at 416, a selection of a particular set of partners output at 414 from SCM company 310 regarding a project and/or time period associated with a desired project. The selection may then trigger a set of obligations for the selected partners and or predicted GHG emissions that are reported (or recorded) to update the carbon offset commitment blockchain 330, the GHG emission reporting blockchain 340, and/or the GHG marketplace 320 generally.

As discussed above, example implementations involve an innovative method or apparatus to provide (1) a GHG marketplace that satisfies the desire for quantifiable and verifiable GHG consumption and/or production (e.g., a total GHG impact of a set of processes and or projects) and (2) to provide recommendations for GHG offset partners and/or transactions based on the information used to define the GHG marketplace. In some aspects, the innovative method or apparatus may receive information relating to one or more of a GHG consumption or a GHG production from a plurality of entities associated with a GHG-offset marketplace. The method or apparatus may then receive a request regarding a desired transaction related to the GHG-offset marketplace and recommend, based on the request and the information relating to the one or more of the GHG consumption or the GHG production, at least one optimized set of partner entities in the plurality of entities for fulfilling the request. The information relating to one or more of a GHG consumption or a GHG production from a plurality of entities associated with a GHG-offset marketplace, in some aspects, may be quantifiable and/or verifiable data provided in accordance with a standard by each participant in the GHG marketplace to generate a standardized, single truth, and traceable GHG marketplace (or GHG marketplace model) across the supply chain (e.g., across different actors and different components (scopes of the GHG protocol) of the supply chain for each actor).

Accordingly, a GHG marketplace and/or GHG marketplace model may be built in accordance with aspects of the disclosure to build quantitative models for green supplier (GS) selection. To build the quantitative model (e.g., a single truth or shared view of the underlying marketplace), in some aspects, the supply chain partners and other stakeholders (e.g., participants and/or actors in the GHG marketplace) may share quantitative data that are standardized, traceable, and auditable. The supply chain partners and stakeholders share the single truth of the environmental impact information among the participants and/or actors in the GHG marketplace (e.g., a supply chain consortium) having carbon target reductions and participating in the carbon credit trading ecosystem.

For example, for large organizations it may be important to choose supply chain partners that will enable them to meet mandatory and/or statutory carbon footprint goals. Such mandatory and/or statutory GHG reduction goals may be associated with a need for more evidence-based reporting and commitment to generating a single truth relating to activities that contribute to direct and indirect GHG emissions. In some aspects of the disclosure, the method or apparatus enables companies (e.g., or a supply chain management company (SCM)) participating in the GHG marketplace to use GHG emission reporting by their supply chain partners and their commitments for GHG emission reduction to build a probabilistic estimate model for direct and indirect carbon emissions. The method or apparatus, in some aspects, enables each company (or the SCM company) participating in the GHG marketplace to build optimization models for recommending partners in the GHG marketplace (e.g., a network of partners of the SCM company) based on current reported GHG emissions report of partners that best achieve a GHG emission reduction target of the company (or the network managed by the SCM company). In some aspects, the method or apparatus may enable a company (or the SCM company) to build optimization models of recommended partners in the GHG network (or the network of partners of the SCM company) that best achieve target GHG emission reduction of the company (or the SCM company) based on different partners' commitments to the company (or the SCM company) for offsetting carbon emissions based on purchasing carbon credits. Additionally, if a partner is accepted then the method or apparatus may, in some aspects, enable the carbon credits to be locked and/or escrowed.

In some aspects, system, method, and/or apparatus (e.g., a Green Supply Chain Partner Recommendation system) in accordance with some aspects of this disclosure may provide a method to recommend partners that minimizes or achieves a target Total GHG/Carbon Footprint (TGF) for a project and/or a time period. The system, method, and/or apparatus, in some aspects may enable the onboarding of SC partners to share non-repudiated and/or validated environmental qualitative and/or quantitative data that is trackable and/or traceable. The system, method, and/or apparatus, in some aspects may provide a single truth (a shared view of a GHG marketplace) and evidence-based tracking of environmental activities among SC partners. Automation of SC partner selection and policy implementation for carbon emission reductions using smart contracts may be provided in some aspects by the system, method, and/or apparatus. Additionally, the system, method, and/or apparatus may recommend ways to reduce emissions and use carbon offsets by carbon credits at the level of supply chain partners.

FIG. 8 illustrates an example computing environment with an example computer device suitable for use in some example implementations. Computer device 805 in computing environment 800 can include one or more processing units, cores, or processors 810, memory 815 (e.g., RAM, ROM, and/or the like), internal storage 820 (e.g., magnetic, optical, solid-state storage, and/or organic), and/or IO interface 825, any of which can be coupled on a communication mechanism or bus 830 for communicating information or embedded in the computer device 805. IO interface 825 is also configured to receive images from cameras or provide images to projectors or displays, depending on the desired implementation.

Computer device 805 can be communicatively coupled to input/user interface 835 and output device/interface 840. Either one or both of the input/user interface 835 and output device/interface 840 can be a wired or wireless interface and can be detachable. Input/user interface 835 may include any device, component, sensor, or interface, physical or virtual, that can be used to provide input (e.g., buttons, touch-screen interface, keyboard, a pointing/cursor control, microphone, camera, braille, motion sensor, accelerometer, optical reader, and/or the like). Output device/interface 840 may include a display, television, monitor, printer, speaker, braille, or the like. In some example implementations, input/user interface 835 and output device/interface 840 can be embedded with or physically coupled to the computer device 805. In other example implementations, other computer devices may function as or provide the functions of input/user interface 835 and output device/interface 840 for a computer device 805.

Examples of computer device 805 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 805 can be communicatively coupled (e.g., via IO interface 825) to external storage 845 and network 850 for communicating with any number of networked components, devices, and systems, including one or more computer devices of the same or different configuration. Computer device 805 or any connected computer device can be functioning as, providing services of, or referred to as a server, client, thin server, general machine, special-purpose machine, or another label.

IO interface 825 can include but is not limited to, wired and/or wireless interfaces using any communication or IO protocols or standards (e.g., Ethernet, 802.11x, Universal System Bus, WiMax, modem, a cellular network protocol, and the like) for communicating information to and/or from at least all the connected components, devices, and network in computing environment 800. Network 850 can be any network or combination of networks (e.g., the Internet, local area network, wide area network, a telephonic network, a cellular network, satellite network, and the like).

Computer device 805 can use and/or communicate using computer-usable or computer readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid-state media (e.g., RAM, ROM, flash memory, solid-state storage), and other non-volatile storage or memory.

Computer device 805 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C #, Java, Visual Basic, Python, Perl, JavaScript, and others).

Processor(s) 810 can execute under any operating system (OS) (not shown), in a native or virtual environment. One or more applications can be deployed that include logic unit 860, application programming interface (API) unit 865, input unit 870, output unit 875, and inter-unit communication mechanism 895 for the different units to communicate with each other, with the OS, and with other applications (not shown). The described units and elements can be varied in design, function, configuration, or implementation and are not limited to the descriptions provided. Processor(s) 810 can be in the form of hardware processors such as central processing units (CPUs) or in a combination of hardware and software units.

In some example implementations, when information or an execution instruction is received by API unit 865, it may be communicated to one or more other units (e.g., logic unit 860, input unit 870, output unit 875). In some instances, logic unit 860 may be configured to control the information flow among the units and direct the services provided by API unit 865, the input unit 870, the output unit 875, in some example implementations described above. For example, the flow of one or more processes or implementations may be controlled by logic unit 860 alone or in conjunction with API unit 865. The input unit 870 may be configured to obtain input for the calculations described in the example implementations, and the output unit 875 may be configured to provide an output based on the calculations described in example implementations.

Processor(s) 810 can be configured to obtain information relating to one or more of a greenhouse gas (GHG) consumption or a GHG production associated with a plurality of entities associated with a GHG-offset marketplace. The processor(s) 810 can be configured to receive a request regarding a desired transaction related to the GHG-offset marketplace. The processor(s) 810 can be configured to recommend, based on the request and the information relating to the one or more of the GHG consumption or the GHG production, at least one optimized set of partner entities in the plurality of entities for fulfilling the request.

The processor(s) 810 can also be configured to generate a model representing a unified GHG marketplace based on the information relating to the one or more of the GHG consumption or the GHG production. The processor(s) 810 can also be configured to evaluate an objective function based on a current set of candidate partner entities. The processor(s) 810 can be configured to compute a tradeoff factor. The processor(s) 810 can also be configured to determine whether a different set of candidate partner entities may improve the objective function. The processor(s) 810 can also be configured to end the first optimization based on determining that the different set of candidate partner entities does not improve the objective function. The processor(s) 810 can also be configured to select an updated set of candidate partner entities based on determining that the different set of candidate partner entities may improve the objective function. The processor(s) 810 can also be configured to receive a selection of partner entities associated with a first optimized set of partner entities in the at least one optimized set of partner entities. The processor(s) 810 can also be configured to provide a set of carbon credit commitments related to the selection of the partner entities to update the information relating to the one or more of the GHG consumption or the GHG production associated with the GHG-offset marketplace.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer readable storage medium or a computer readable signal medium. A computer readable storage medium may involve tangible mediums such as, but not limited to optical disks, magnetic disks, read-only memories, random access memories, solid-state devices, and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the teachings of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general-purpose computer, based on instructions stored on a computer readable medium. If desired, the instructions can be stored on the medium in a compressed and/or encrypted format.

Moreover, other implementations of the present application will be apparent to those skilled in the art from consideration of the specification and practice of the teachings of the present application. Various aspects and/or components of the described example implementations may be used singly or in any combination. It is intended that the specification and example implementations be considered as examples only, with the true scope and spirit of the present application being indicated by the following claims.

What is claimed is:

1. A method comprising:
obtaining information relating to one or more of a greenhouse gas (GHG) consumption or a GHG production associated with a plurality of entities associated with a GHG-offset marketplace;
receiving a request regarding a desired transaction related to the GHG-offset marketplace; and
recommending, based on the request and the information relating to the one or more of the GHG consumption or the GHG production, at least one optimized set of partner entities in the plurality of entities for fulfilling the request.

2. The method of claim 1 further comprising:
generating a model representing a unified GHG marketplace based on the information relating to the one or more of the GHG consumption or the GHG production.

3. The method of claim 2, wherein the model comprises:
a first set of data relating to a set of commitments made by a set of entities in the plurality of entities;
a second set of data relating to monitoring and extracting—GHG emission that is reported by each particular entity in the set of entities—to an external Mandatory/Statutory GHG emission reporting agency; and
a third set of data used related to predicting one of GHG production or GHG consumption for each entity in the plurality of entities, wherein the third set of data is based on at least one of the first set of data and the second set of data.

4. The method of claim 1, wherein the request relates to a supply chain activity associated with one or more of a product, a project, an enterprise, or a service.

5. The method of claim 4, wherein the request indicates a target GHG emission parameter associated with a desired GHG offset.

6. The method of claim 1, wherein the at least one optimized set of partner entities comprises at least one of a manufacturing entity, a construction entity, a transportation entity, a distributor entity, or a retail entity.

7. The method of claim 1, wherein recommending the at least one optimized set of partner entities comprises a first optimization of an objective function based on a set of reported GHG footprints (GFs) of candidate partner entities in the plurality of entities.

8. The method of claim 7, wherein recommending the at least one optimized set of partner entities further comprises computing a tradeoff factor, wherein, for a tradeoff factor above a threshold value, data is retrieved regarding at least one candidate partner entity regarding a potential GF offset by the at least one candidate partner entity.

9. The method of claim 7, wherein the first optimization of the objective function comprises, for a current set of candidate partner entities, iteratively, (1) evaluating the objective function based on the current set of candidate partner entities, (2) determining whether a different set of candidate partner entities may improve the objective function, and (3) one of (i) ending the first optimization based on determining that the different set of candidate partner entities does not improve the objective function or (ii) selecting an updated set of candidate partner entities based on determining that the different set of candidate partner entities may improve the objective function.

10. The method of claim 1, wherein the at least one optimized set of partner entities comprises multiple sets of optimized partner entities.

11. The method of claim 1 further comprising:
receiving a selection of partner entities associated with a first optimized set of partner entities in the at least one optimized set of partner entities.

12. The method of claim 11 further comprising:
providing a set of carbon credit commitments related to the selection of the partner entities to update the information relating to the one or more of the GHG consumption or the GHG production associated with the GHG-offset marketplace.

13. The method of claim 12, wherein the set of carbon credit commitments is recorded in a blockchain ledger.

14. An apparatus comprising:
a memory; and
at least one processor coupled to the memory and, based at least in part on information stored in the memory, the at least one processor is configured to:
obtain information relating to one or more of a greenhouse gas (GHG) consumption or a GHG production associated with a plurality of entities associated with a GHG-offset marketplace;
receive a request regarding a desired transaction related to the GHG-offset marketplace; and
recommend, based on the request and the information relating to the one or more of the GHG consumption or the GHG production, at least one optimized set of partner entities in the plurality of entities for fulfilling the request.

15. The apparatus of claim 14, the at least one processor further configured to:
generate a model representing a unified GHG marketplace based on the information relating to the one or more of the GHG consumption or the GHG production, wherein the model comprises (1) a first set of data relating to a set of commitments made by a set of entities in the plurality of entities; (2) a second set of data relating to monitoring whether each particular entity in the set of entities is meeting a subset of the set of commitments associated with the particular entity; and (3) a third set of data used related to predicting one of GHG production or GHG consumption for each entity in the plurality of entities, wherein the third set of data is based on at least one of the first set of data and the second set of data.

16. The apparatus of claim 14, wherein the at least one processor is configured to recommend the at least one optimized set of partner entities by performing a first optimization of an objective function based on a set of reported GHG footprints (GFs) of candidate partner entities in the plurality of entities, wherein the first optimization of the objective function comprises, for a current set of candidate partner entities, iteratively, (1) evaluating the objective function based on the current set of candidate partner entities, (2) determining whether a different set of candidate partner entities may improve the objective function, and (3) one of (i) ending the first optimization based on determining that the different set of candidate partner entities does not improve the objective function or (ii) selecting an updated set of candidate partner entities based on determining that the different set of candidate partner entities may improve the objective function.

17. The apparatus of claim 14, the at least one processor further configured to:
receive a selection of partner entities associated with a first optimized set of partner entities in the at least one optimized set of partner entities; and
provide a set of carbon credit commitments related to the selection of the partner entities to update the information relating to the one or more of the GHG consumption or the GHG production associated with the GHG-offset marketplace.

18. A computer-readable medium storing computer executable code, the computer executable code when executed by a processor causes the processor to:
obtain information relating to one or more of a greenhouse gas (GHG) consumption or a GHG production associated with a plurality of entities associated with a GHG-offset marketplace;
receive a request regarding a desired transaction related to the GHG-offset marketplace; and
recommend, based on the request and the information relating to the one or more of the GHG consumption or the GHG production, at least one optimized set of partner entities in the plurality of entities for fulfilling the request.

19. The computer-readable medium of claim 18, the computer executable code when executed by a processor further causes the processor to:
generating a model representing a unified GHG marketplace based on the information relating to the one or more of the GHG consumption or the GHG production, wherein the model comprises (1) a first set of data relating to a set of commitments made by a set of entities in the plurality of entities; (2) a second set of data relating to monitoring whether each particular entity in the set of entities is meeting a subset of the set of commitments associated with the particular entity; and (3) a third set of data used related to predicting one of GHG production or GHG consumption for each entity in the plurality of entities, wherein the third set of data is based on at least one of the first set of data and the second set of data.

20. The computer-readable medium of claim 18, wherein recommending the at least one optimized set of partner entities comprises a first optimization of an objective function based on a set of reported GHG footprint (GF) of candidate partner entities in the plurality of entities, wherein the first optimization of the objective function comprises, for a current set of candidate partner entities, iteratively, (1) evaluating the objective function based on the current set of candidate partner entities, (2) determining whether a different set of candidate partner entities may improve the objective function, and (3) one of (i) ending the first optimization based on determining that the different set of candidate partner entities does not improve the objective function or (ii) selecting an updated set of candidate partner entities based on determining that the different set of candidate partner entities may improve the objective function.
